(19) United States
(12) Patent Application Publication
(10) Pub. No.: US 2024/0100483 A1
(43) Pub. Date: Mar. 28, 2024

(54) SINGLE PASS ELECTRO-SEPARATION SYSTEM

(71) Applicant: AEGROS PTY LTD, New South Wales (AU)

(72) Inventor: David Ogle, New South Wales (AU)

(73) Assignee: AEGROS PTY LTD, New South Wales (AU)

(21) Appl. No.: 18/264,272

(22) PCT Filed: Feb. 4, 2022
(86) PCT No.: PCT/AU2022/050057

§ 371 Date: Aug. 4, 2023

(30) Foreign Application Priority Data
Feb. 5, 2021 (AU) 2021900275

(51) Int. Cl. B01D 61/50; B01D 17/06; B01D 63/08

(52) U.S. Cl. CPC B01D 61/50; B01D 17/06; B01D 63/0822; B01D 63/084; B01D 2313/086; B01D 2313/14

(57) ABSTRACT

There is provided a single pass electro-separation system for separating substantially all of a charged molecule from a fluid stream in a single pass, the system comprising an assembly adapted to be disposed between a cathode and an anode. The assembly comprises: at least a first, second, and third separation membrane each having defined pore sizes; a first spacer disposed between the first and second separation membranes and having a void extending from an inlet to an outlet to define a first fluid flow path for a first fluid stream between the first and second separation membranes; and a second spacer disposed between the second and third separation membranes and having a void extending from an inlet and an outlet to define a second fluid flow path for a second fluid stream between the second and third separation membranes

### TECHNICAL FIELD

The technology relates to electro-separation systems. In particular, it relates to single-pass electro-separation units that can be used to separate one or more biological molecules from a fluid.

### CROSS-REFERENCE TO RELATED APPLICATION

This application claims priority to Australian provisional patent application number 2021900275 which is incorporated by reference in its entirety.

### BACKGROUND

Charged molecules such as proteins and polysaccharides can be separated by both charge and size by using an electric field to selectively move charged molecules across a membrane which filters the molecules by size. Existing electro-separation systems utilize cartridges comprising multiple separation membranes to facilitate separation of macromolecules by charge and/or molecular weight.

The separations are usually run at constant voltage 150-250V and the separation of the molecules is dependent on the charge-to-mass ratio of the particular molecule. In addition, conventional electro-separation devices circulate the feed and product streams with multiple passes over the membrane. There are a number of disadvantages with conventional electro-separation apparatus which are typically designed for rapid separations by applying the maximum possible voltage (electric field). The disadvantages include ssubstantial power requirements, substantial cooling requirements including the use of heat exchangers.

When high voltages are used, the electro-separation units become hot and cooling of the liquid streams in the units becomes critical. While fluid streams may enter an electro-separation unit at around 5° C., under typical operating conditions the application of an electric field may result in an increase in temperature to about 35° C. when the fluid streams exit the electro-separation unit. At this temperature, sensitive biological components may be denatured, become unstable or lose activity. This limits the length of the flow path that can be used in conventional systems and requires a number of work arounds including externally cooling the fluid containing the molecules to be separated in between multiple passes through the separation unit. This results in the fluid being exposed to multiple cycles of heating and cooling which is further detrimental biological components in the fluid.

Accordingly, there is a need for an improved electro-separation system which can separate all or substantially all of a charged molecule from a fluid in a single pass through the system.

### SUMMARY

In a first aspect, there is provided a single pass electro-separation system for separating substantially all of a charged molecule from a fluid stream in a single pass, the system comprising an assembly adapted to be disposed between a cathode and an anode.

In one embodiment, the assembly comprises:
a. at least a first, second, and third separation membrane having defined pore sizes;
b. a first spacer disposed between the first and second separation membranes and having a void extending from an inlet to an outlet to define a first fluid flow path for a first fluid stream between the first and second separation membranes; and
c. a second spacer disposed between the second and third separation membranes and having a void extending from an inlet and an outlet to define a second fluid flow path for a second fluid stream between the second and third separation membranes.

In an embodiment, each inlet is associated with sealing channels adapted to direct the fluid streams uniformly into the flow paths; and each outlet is associated with sealing channels adapted to direct the fluid streams into the outlet.

In use, the fluid streams travel along the flow paths and an electric field is applied to the fluid streams in the flow paths to cause negatively charged molecules in the fluid streams to move towards the anode and positively charged molecules in the fluid streams to move towards the cathode such that molecules with sizes less than the pore size of the separation membrane will pass across the separation membrane from one fluid path to the other fluid path.

The system may further comprise a molecular barrier between the anode and the first fluid stream to prevent molecules in the first fluid stream contacting the anode. In some embodiments, at least a portion of the first molecular barrier defines a third fluid path between the anode and the first molecular barrier.

The system may further comprise a molecular barrier between the cathode and the second fluid stream to prevent molecules in the second fluid stream contacting the cathode. At least a portion of the second molecular barrier defines a fourth fluid path between the cathode and the second molecular barrier. In use, the third and fourth fluid paths contain an ionic solution to cause a current flow between the electrodes in order to maintain an electric field between the electrodes.

The ionic solution may comprise a buffer. In some embodiments, the ionic solution is a coolant.

In some embodiments, either of the first or second fluid streams is a feed material and the other fluid of the first or second fluid streams contains a molecule or molecules separated from the feed material.

Either or both of the first and second flow paths are a series of linear paths linked by turns, a zigzag, a spiral or other torturous path.

The assembly may be adapted to be removably received in a housing.

The assembly may further comprise at least one additional spacer and at least one additional separation membrane wherein the additional spacer is disposed between the third and the additional separation membranes and having a void extending from an inlet to an outlet and defining a fluid flow path in communication with the first or the second fluid flow paths.

Each of the separation membranes may have the same or different defined pore sizes.

In some embodiments, the first fluid stream is in the same direction as the second fluid stream. In other embodiments, the first fluid stream is in the opposite direction to the second fluid stream.

In some embodiments, at least the first fluid stream and the second fluid stream follow parallel paths.

In some embodiments, the flow rate along the fluid stream path of each stream is the same.

In some embodiments, at least the first fluid stream and the second fluid stream follow non-parallel paths, such as a taper.

In some embodiments, the flow rate along the fluid stream path of each stream varies.

In some embodiment, the sealing channels comprise a series of substantially parallel channels.

In some embodiments, the sealing channels comprise a series of small holes.

In an embodiment, the flow rate of any one of the fluid streams is between 5 and 100 mL/min.

In an embodiment, the flow rate of any one of the fluid streams is between 5 and 50 mL/min.

In an embodiment, the flow rate of any one of the fluid streams is about 20 mL/min.

### Definitions

Throughout this specification, unless the context clearly requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term ‘consisting of’ means consisting only of.

Any discussion of documents, acts, materials, devices, articles or the like which has been included in the present specification is solely for the purpose of providing a context for the present technology. It is not to be taken as an admission that any or all of these matters form part of the prior art base or were common general knowledge in the field relevant to the present technology as it existed before the priority date of each claim of this specification.

Unless the context requires otherwise or specifically stated to the contrary, integers, steps, or elements of the technology recited herein as singular integers, steps or elements clearly encompass both singular and plural forms of the recited integers, steps or elements.

In the context of the present specification the terms ‘a’ and ‘an’ are used to refer to one or more than one (i.e., at least one) of the grammatical object of the article. By way of example, reference to ‘an element’ means one element, or more than one element.

In the context of the present specification, the term ‘about’ means that reference to a figure or value is not to be taken as an absolute figure or value, but includes margins of variation above or below the figure or value in line with what a skilled person would understand according to the art, including within typical margins of error or instrument limitation. In other words, use of the term ‘about’ is understood to refer to a range or approximation that a person or skilled in the art would consider to be equivalent to a recited value in the context of achieving the same function or result.

Those skilled in the art will appreciate that the technology described herein is susceptible to variations and modifications other than those specifically described. It is to be understood that the technology includes all such variations and modifications. For the avoidance of doubt, the technology also includes all of the steps, features, and compounds referred to or indicated in this specification, individually or collectively, and any and all combinations of any two or more of said steps, features and compounds.

In order that the present technology may be more clearly understood, preferred embodiments will be described with reference to the following drawings and examples.

### BRIEF DESCRIPTION OF THE DRAWINGS

FIG. 1 is an illustration of a spacer.

FIG. 2 is an illustration of an assembly comprising a separation membrane disposed between a first and second spacer with outer molecular barriers.

FIG. 3a is an illustration of multiple assemblies in series with parallel flow of the first and second streams.

FIG. 3b is an illustration of multiple assemblies in series with contra flow of the first and second streams.

FIG. 4 is an illustration of multiple assemblies in parallel.

FIG. 5a is an illustration of a hexagonal spacer.

FIG. 5b is an illustration of multiple hexagonal assemblies in series with parallel flow of the first, second and third streams.

FIG. 6 is an exploded view of a single pass electro-separation system.

FIG. 7 is a cross sectional view through a single pass electro-separation system.

FIG. 8 is an illustration of a large format membrane spacer and detail of the sealing channels. FIG. 8a show the sealing channels having U-shaped cross section while FIG. 8b illustrates the sealing channels as a tubes within a thickness of the spacer.

FIG. 9 is an exploded view of larger format separation unit.

FIG. 10 is an illustration of an embodiment of a spacer with a circular shape and spiral flow path.

### DESCRIPTION

The present invention relates to a single pass electro-separation system (SPES) suitable for charged macro and micro molecule separations. Unlike previous electrophoresis systems, which have flow recirculation, the SPES described herein features a prolonged flow path that allows complete or nearly complete separation to occur in a single pass through the system.

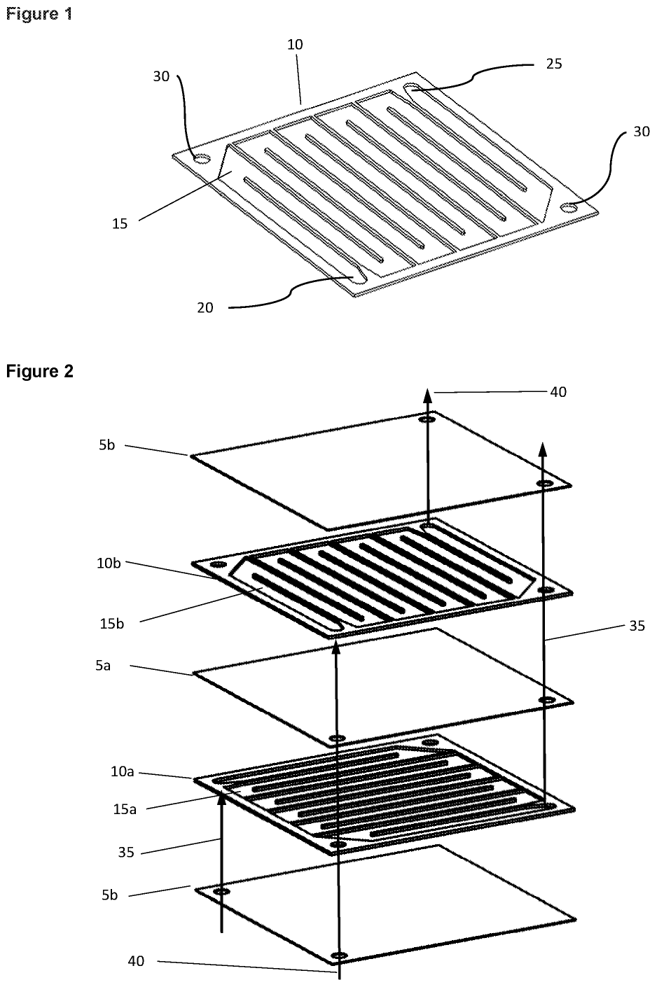

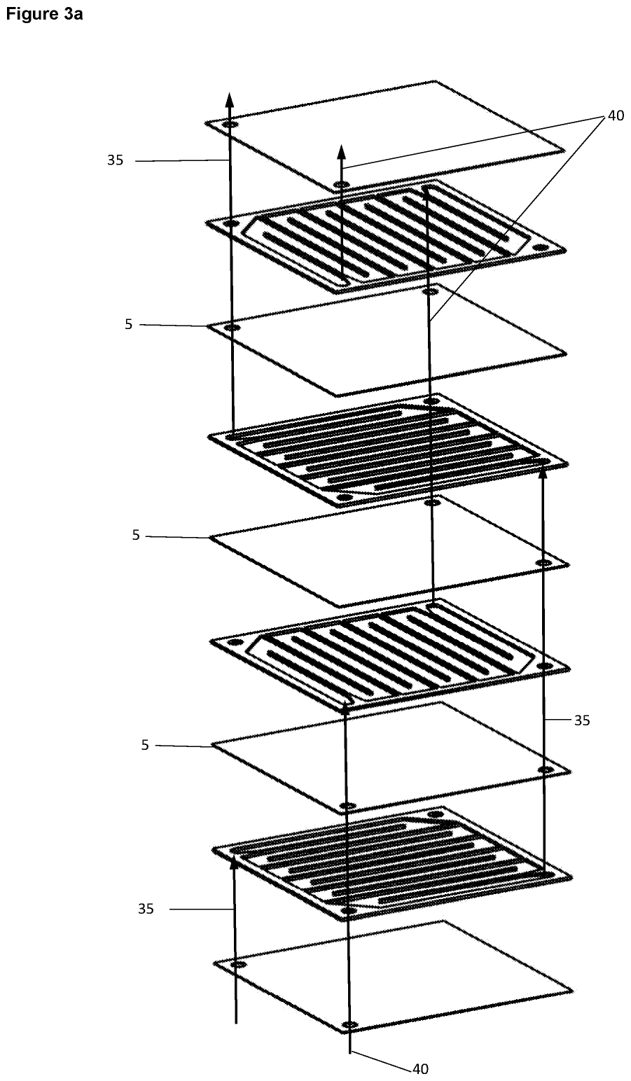

With reference to FIGS. 1 and 2, the system comprises an assembly adapted to be disposed between a cathode and an anode. The assembly comprises at least a first (5b), second (5a) and third membrane (5b) having defined pore sizes. The second membrane (5a) is a separation membrane. The first and third membranes (5b) are molecular barriers. A first spacer (10a) is disposed between the first and second membranes and has a void (15) extending from an inlet (20) to an outlet (25) to define a first fluid flow path for a first fluid stream between the first and second separation membranes and the spacer (10a) also has ports (30) for the second fluid stream to pass through. Fluid flows along the flow path from the inlet (20) to the outlet (25) through the void (15a) in the spacer (10a) thereby maximising the length of the flow path.

The second spacer (10b) is disposed between the second and third membranes and has a void (15b) extending from an inlet (20) to an outlet (25) to define a second fluid flow path for a second fluid stream between the second and third membranes. Within the first spacer, the fluid flows along the flow path from the inlet (20) to the outlet (25) through the void (15b) in the spacer (10b) thereby maximising the length of the flow path.

The inlet (20) is in fluid communication with sealing channels or ports (30) adapted to direct the fluid stream uniformly across flow path. Similarly, the outlet (25) is in fluid communication with sealing channels adapted to receive the fluid stream from the flow path and direct it to the outlet.

In use, the first fluid stream (35) travels along the first flow path, and the second fluid stream (40) travels along the second flow path. An electric field is applied to the fluid streams in the flow paths to cause negatively charged molecules in the fluid streams to move towards the anode and positively charged molecules in the fluid streams to move towards the cathode. Molecules with sizes less than the pore size of the separation membrane will pass across the separation membrane from one fluid path to the other fluid path.

Typically one of the fluid streams is a feed stream containing molecules to be separated and the second stream is the product stream which receives molecules that have passed through the separation membrane on the application of an electric field.

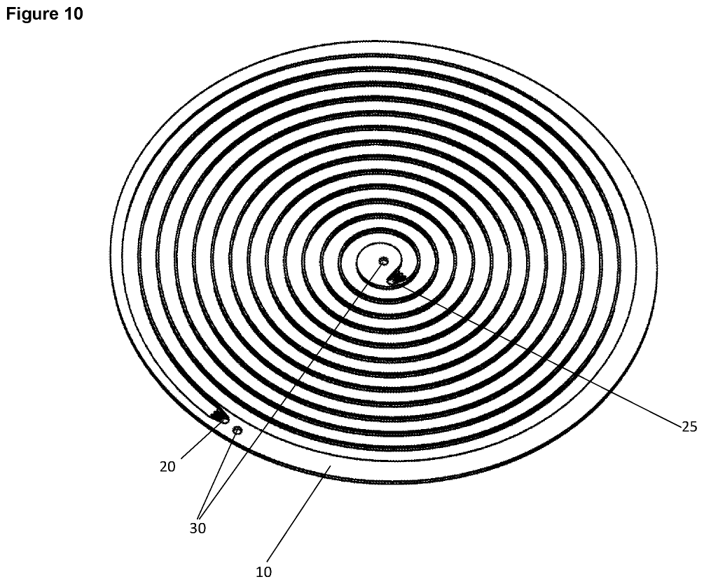

In some embodiments, the void in the spacer, and hence the flow path, is a series of linear paths linked by turns. Alternatively, the flow path may be a zig zag, or spiral (see for example FIG. 10). In some embodiments, the flow path is as long as possible to maximise the time fluid stream is exposed to the electric field and thereby reducing or eliminating the need to recirculate a fluid stream to achieve effective separation of a molecule.

In some embodiments, the void in the spacer has parallel sides and hence a constant cross-section. In this embodiment, the fluid flow rates are constant along the flow path

In some embodiments the void in the spacer has non-parallel sides, such as a wedge. In this embodiment, the fluid flow rate is variable along the flow path.

Typically, the first and third membranes are molecular barriers with a smaller defined pore size than the second membrane, which is a separation membrane.

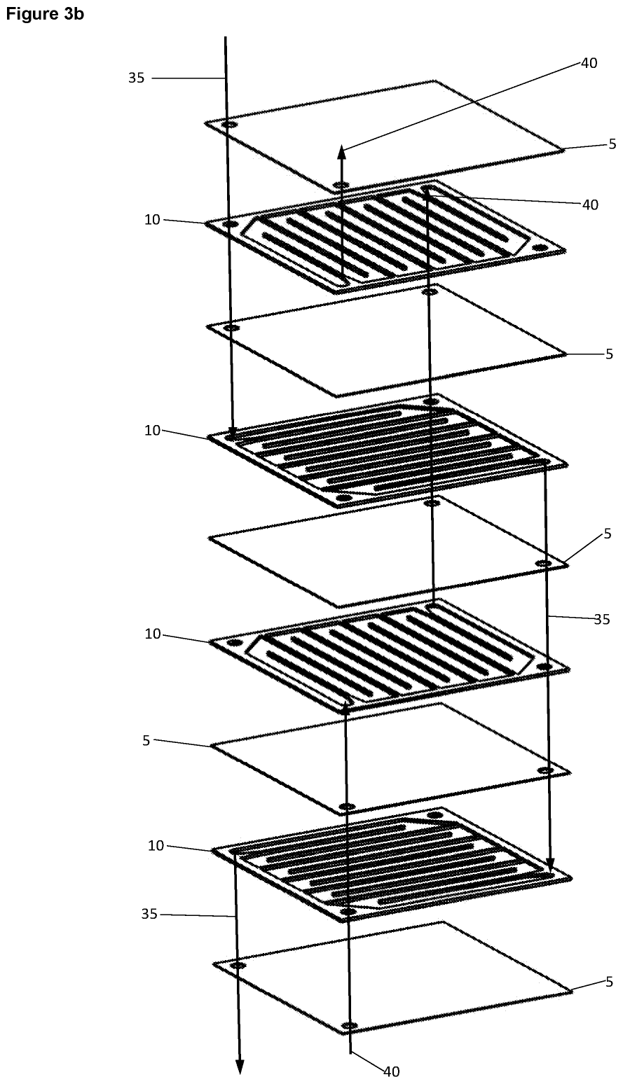

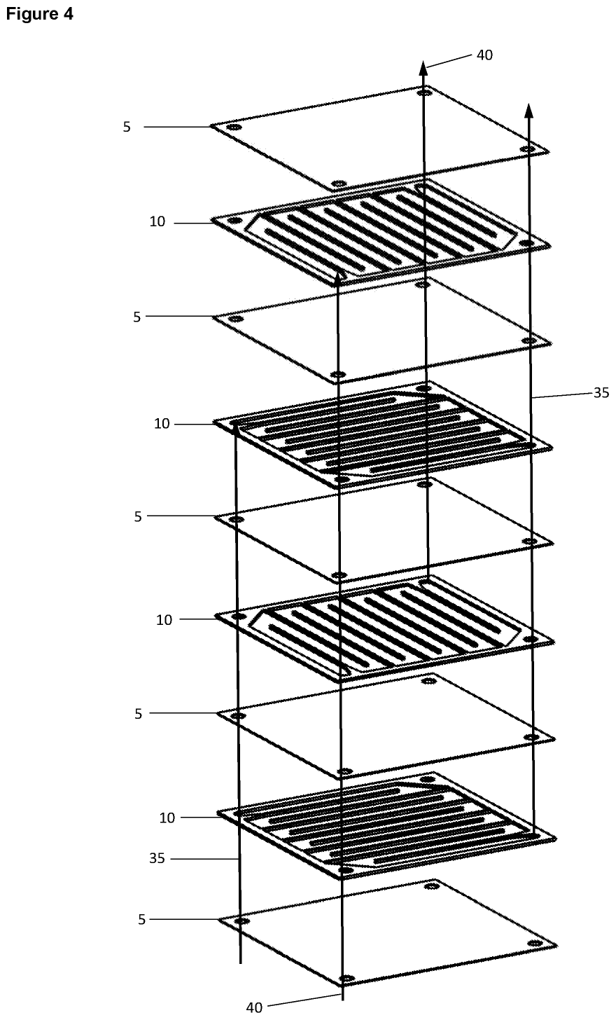

With reference to FIGS. 3 and 4, in some embodiments the assembly comprises at least two additional spacers and at least two additional membranes wherein the additional spacer is disposed between the third and the additional separation membranes. As above, each additional spacer has a void extending from an inlet to an outlet to define a flow path for a fluid stream between the third and the additional separation membranes. This flow path is in communication with the first or the second fluid flow paths.

In this way further spacers and separation membranes can be added to the assembly to create a stack of alternating spacers and membranes with the first fluid flow path for the first fluid stream and the second fluid flow path for the second fluid stream extending through the assembly.

The use of stacked membranes and spacers in the assembly minimises the distance between the electrodes and maximizes the electric field strength.

In FIGS. 3 and 4, the first and second fluid streams are illustrated as flowing in the same direction However, in other embodiments, the first and second fluid streams flow in opposite directions.

Some embodiments provide for an assembly comprising a stack of 6 spacers in series, where the path length of the first and/or second flow path is about 50 meters. In other embodiments, the path length of the first and/or second flow path in an assembly comprising 6 spacers is from about 9 meters to about 50 meters.

In one embodiment, multiple spacers and membranes are arranged in series, thereby increasing the length of the flow path each layer as shown in FIG. 3. For example, in FIG. 3a the first fluid stream (35) and second fluid stream (40) run in parallel. In an alternate embodiment, FIG. 3b shows the first fluid stream (35) and second fluid stream (40) run in opposite directions (contra flow). In these embodiments, separation membranes with two ports (holes) are used. However, the invention is not limited to the use of two ports (holes).

Alternatively, multiple spacers and membranes are arranged in parallel, as shown in FIG. 4. Membranes with four ports (holes) are used for parallel connection.

Preferably, in the embodiments illustrated in FIGS. 3 and 4, the first, third and fifth membranes are molecular barriers with a smaller pore size than the second and forth membranes which are separation membranes

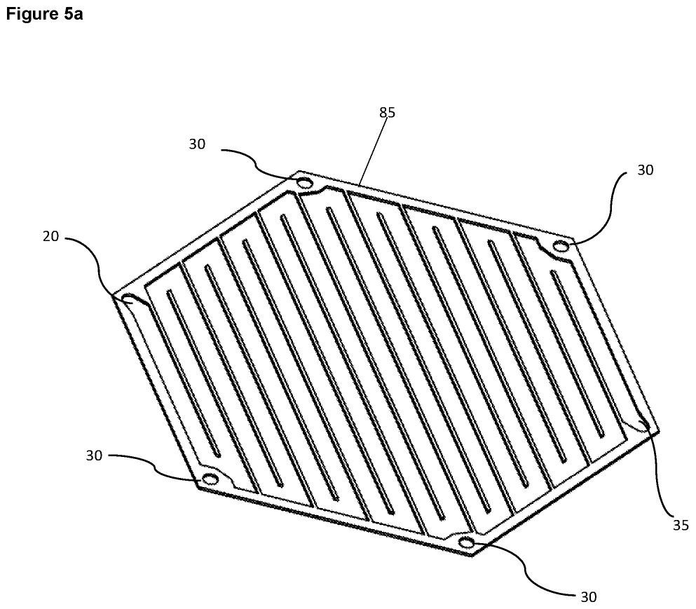

With reference to FIG. 5, hexagonal spacers (85) and membranes (5) may be used is some embodiments. The hexagonal spacers have 4 ports (30) as well as an inlet (20) and an outlet (35). This arrangement allows for a first fluid stream (35), a second fluid stream (40), and a third fluid stream (42). For example, these may be a feed stream and two product streams respectively.

In one embodiment, the feed stream can be central with a separation membrane either side. Charged molecules, such as proteins, are separated from the feed stream, Positive molecules, such as positively charged proteins, go one way through one separation membrane and negative molecules, such as negatively charged proteins, go the other way through the other separation membrane thereby allowing two product streams, one with positive proteins and the other with negative proteins.

In some embodiments (not shown) the feed stream (e.g. fluid stream 1) can be passed between two membranes such that positively charged molecules pass through one membrane into a product stream (e.g. fluid stream 2) and negatively charged molecules pass through another membrane into a second product stream (e.g. fluid stream 3) using a separation membrane disposed between the feed stream and the product stream.

In another embodiment, a feed stream (e.g. fluid stream 1) is passed across a first membrane with charged molecules pass through the first membrane into a product stream (e.g. fluid stream 2). The product stream runs between the first membrane and a second membrane having a pores size less than the first membrane. Charged molecules pass across the second membrane into a second product stream (e.g. fluid stream 3). The charged molecules may be positively charged or negatively charged.

In a preferred embodiment, the assembly is adapted to be removably received in a housing comprising a body (45) and a cover (50) that sealingly engages with the body (45). In some embodiments, the body (45) comprises an electrode (either an anode or a cathode) and the cover (50) also comprises an electrode (either an anode or a cathode). In some embodiments, the body (45) comprises an anode and the cover (50) comprises a cathode. In other embodiments, the body (45) comprises an cathode and the cover (50) comprises an anode.

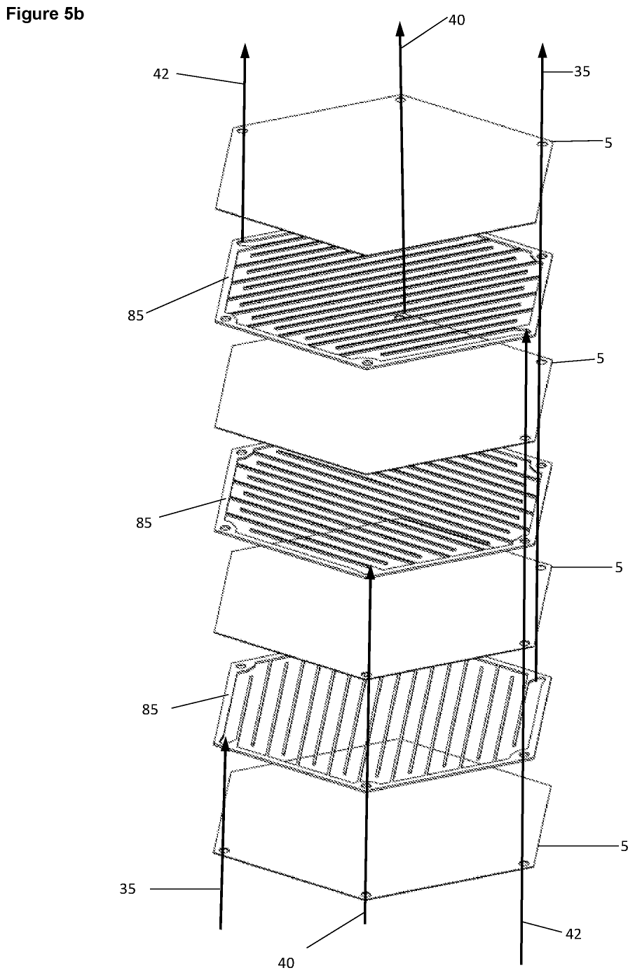

The first fluid stream enters the housing through an inlet (55) and the second fluid stream enters the housing through an inlet (60). The first fluid stream exits the housing through an outlet (65) and the second fluid stream exits the housing through an outlet (70). With reference to FIG. 6, the inlets (55, 60) shown on the body (45) and the outlets (65, 70) are shown on the cover (50). In other embodiments the inlets may be present in the cover and the outlets in the body or the cover and body may have an outlet and an inlet. In one embodiment the inlets and outlets can be interchanged to facilitate parallel flow or contraflow of the first and second streams.

In some embodiments the system comprises a molecular barrier between the anode and the first fluid stream (35) to prevent molecules in the first fluid stream (35) contacting the anode. In this embodiment at least a portion of the first molecular barrier defines a third fluid path between the anode and the first molecular barrier.

The system can also comprise a molecular barrier between the cathode and the second fluid stream (40) to prevent molecules in the second fluid stream (40) contacting the cathode. In this embodiment at least a portion of the second molecular barrier defines a fourth fluid path between the cathode and the second molecular barrier.

The third and fourth fluid paths can be used to contain an ionic solution to cause a current flow between the electrodes in order to maintain an electric field between the electrodes. The ionic solution can comprise a buffer and in some embodiments may be used as a coolant.

The ionic solution is typically water based but may contain one or more water soluble chemically inert coolant substances having a high thermal capacity and low viscosity, such as ethylene glycol.

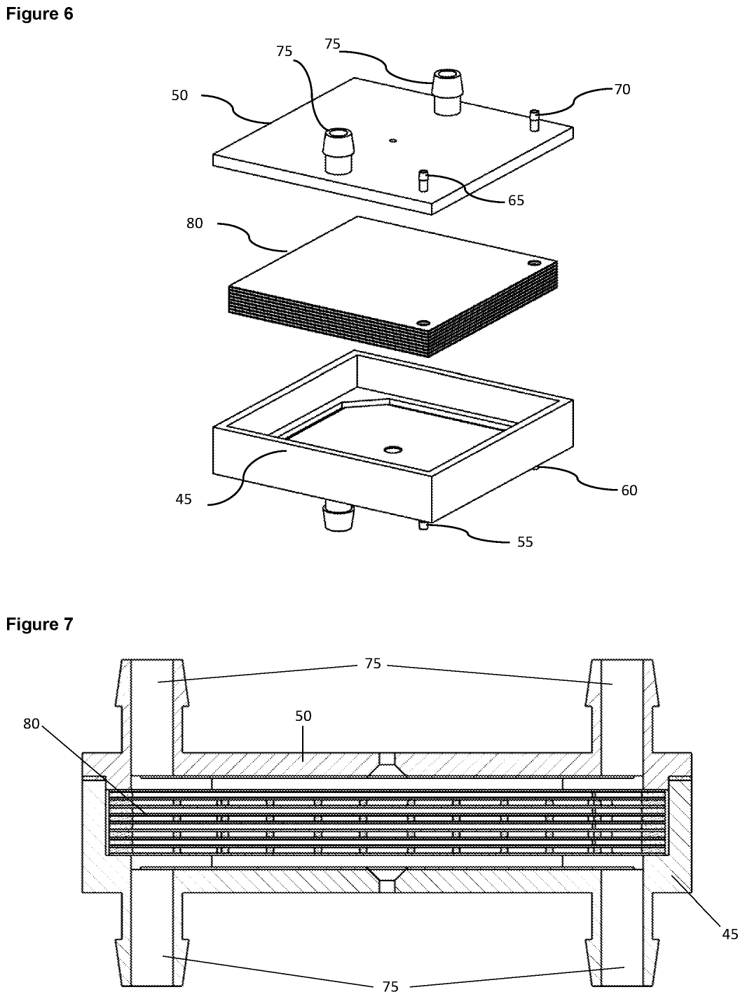

With reference to FIGS. 6 and 7, the buffer can flow through the housing via the buffer ports (75) and around the assembly (80). In some embodiments, the buffer may be cooled and recirculated thorough the system, via the buffer ports (75).

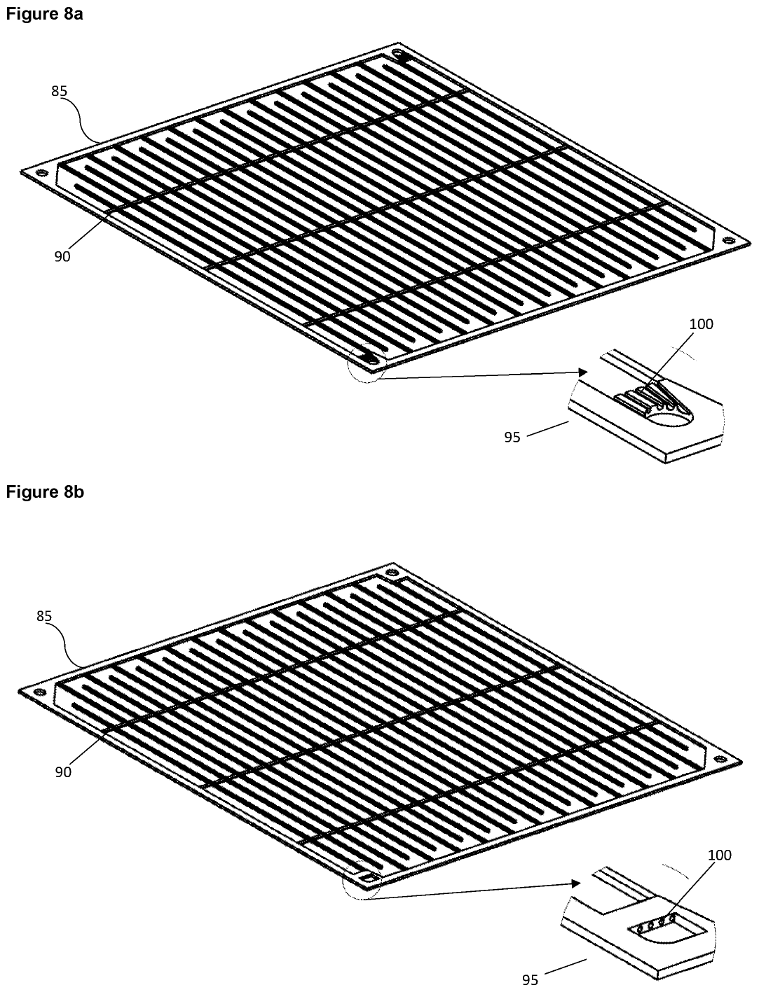

FIG. 8 shows an alternate embodiment of a spacer (85) in a large format with supports (90) to maintain the channel.

FIG. 8a shows the detail of the sealing channels (95) present at the inlet and outlet of the spacer. The sealing channels (95) comprise a series of substantially parallel channels (100) leading to the flow path. In this embodiment, the channels (100) do not extend the full thickness of the spacer. In an alternate embodiment, as illustrated in FIG. 8b, the sealing channels (100) are in the form of tubes contained within a thickness of the spacer (85).

The sealing channels (100) are not shown on the simplified diagrams (FIGS. 1-7). The sealing channels provide support between the membrane and adjacent spacer (85) and the present inventors have found that the sealing channels (100) minimise or prevent leakage and mixing of the first fluid stream (35) and second fluid stream (40).

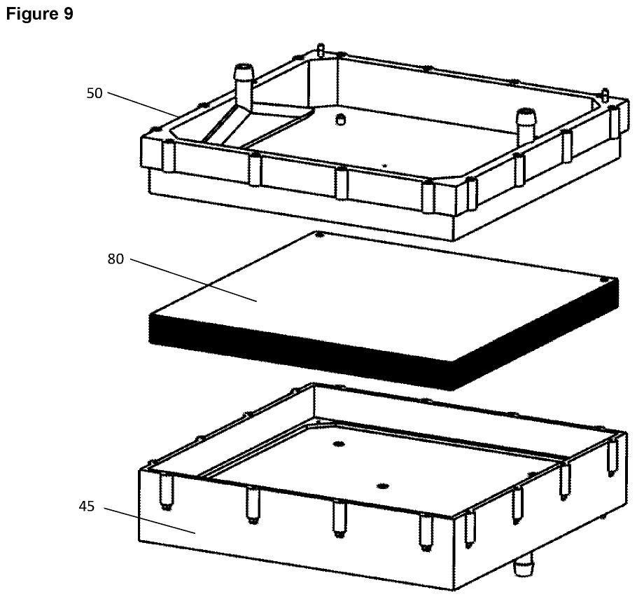

FIG. 9 is an exploded view of a large format system and housing comprising a body (45) and cover (50).

When the system is in use, the fluid streams travel along the flow paths. An electric field is applied to the fluid streams in the flow paths to cause negatively charged molecules in the fluid streams to move towards the anode and positively charged molecules in the fluid streams to move towards the cathode such that molecules with sizes less than the pore size of the separation membrane will pass across the separation membrane from one fluid path to the other fluid path.

In some embodiments, a voltage of about 50V is applied.

Typical flow rates used with the system described herein are around 5 to 100 ml/min. For example, the flow rate could be around any one of 5, 10, 15, 20, 25, 30, 35, 40, 45, 50, 55, 60, 65, 70, 75, 80, 85, 90, 95, or 100 ml/min. In an embodiment, the flow rate is between 5 and 50 mUmin. In a further embodiment, the flow rate is about 20 mL per minute.

Either of the first or second fluid streams can be a feed material containing molecules of interest to be separated from the feed material. Feed material may be for examples blood, blood plasma or other biological fluids such as cell culture supernatant.

In some embodiments, the system does not include a heat exchanger or other cooling apparatus.

The advantages of the single-pass electro-separation system described herein include the ability to use lower power due to the long flow paths. In addition low flow rates may be used as there is no need to recirculate the fluid streams to ensure complete or substantially complete separation of the charged molecules.

The two outer fluid streams over the electrodes can be chilled to provide cooling to the inner fluid streams. The flow rates in the outer electrode fluid streams are typically much higher for cooling. Typically flow rates in the outer electrode fluid streams are 10 L/min for cooling.

Further, while the fluid streams are typically chilled, this can be achieved using prechilled fluid, or performing the separation in a cold environment rather than having dedicated heat exchangers for active cooling of the fluid streams.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A single pass electro-separation system for separating substantially all of a charged molecule from a fluid stream in a single pass, the system comprising an assembly adapted to be disposed between a cathode and an anode; wherein the assembly comprises:
a. at least a first, second, and third separation membrane each having defined pore sizes;
b. a first spacer disposed between the first and second separation membranes and having a void extending from an inlet to an outlet to define a first fluid flow path for a first fluid stream between the first and second separation membranes;
c. a second spacer disposed between the second and third separation membranes and having a void extending from an inlet and an outlet to define a second fluid flow path for a second fluid stream between the second and third separation membranes; and
d. a molecular barrier between the anode and the first fluid stream to prevent molecules in the first fluid stream contacting the anode;
wherein either or both of the first and second flow paths are a series of linear paths linked by turns, a zigzag, a spiral or other torturous path.

2. (canceled)

3. The single pass electro-separation system of claim 1, wherein
each inlet is associated with sealing channels adapted to direct the fluid streams uniformly into the flow path;
each outlet is associated with sealing channels adapted to direct the fluid stream into the outlet.

4. The single pass electro-separation system of claim 2, wherein in use, the fluid streams travel along the flow paths and an electric field is applied to the fluid streams in the flow paths to cause negatively charged molecules in the fluid streams to move towards the anode and positively charged molecules in the fluid streams to move towards the cathode such that molecules with sizes less than the pore size of the separation membrane will pass across the separation membrane from one fluid path to the other fluid path.

5. (canceled)

6. The system of claim 1, wherein at least a portion of the first molecular barrier defines a third fluid path between the anode and the first molecular barrier.

7. The system of claim 4, further comprising a molecular barrier between the cathode and the second fluid stream to prevent molecules in the second fluid stream contacting the cathode.

8. The system of claim 5, wherein at least a portion of the second molecular barrier defines a fourth fluid path between the cathode and the second molecular barrier.

9. The system of claim 6, wherein, in use, the third and fourth fluid paths contain an ionic solution to cause a current flow between the cathode and anode in order to maintain an electric field between the cathode and anode.

10-11. (canceled)

12. The system of claim 1, wherein either of the first or second fluid streams is a feed material and the other fluid of the first or second fluid streams contains a molecule or molecules separated from the feed material.

13. (canceled)

14. The system of claim 1, adapted to be removably received in a housing.

15. The system of claim 1, further comprising at least one additional spacer and at least one additional separation membrane wherein the additional spacer is disposed between the third and the additional separation membranes and having a void extending from an inlet to an outlet and defining a fluid flow path in communication with the first or the second fluid flow paths.

16. The system of claim 1, wherein the separation membranes have the same or different defined pore sizes.

17. The system of claim 1, wherein the first fluid stream is in the same direction as the second fluid stream; or wherein the first fluid stream is in the opposite direction to the second fluid stream.

18. (canceled)

19. The system of claim 1, wherein the sealing channels comprise a series of substantially parallel channels.

20. The system of claim 1, wherein the void in the spacer defining at least the first flow path and the second flow path has parallel sides.

21. The system of claim 18, wherein the flow rate along the fluid stream path of each stream is the same.

22. The system of claim 18, wherein the void in the spacer defining at least the first flow path and the second flow path has non-parallel sides.

23. The system of claim 16, wherein the flow rate along the fluid stream path of each stream varies.

24. The system of claim 1, wherein the separation membranes have gradated pore sizes.

25. The system of claim 1, wherein the at least one membrane is integrated into the anode or the cathode.

26. The system of claim 1, wherein the flow rate of any one of the fluid streams is between 5 and 100 mL/min.

27-28. (canceled)
